(19) United States
(12) Patent Application Publication
(10) Pub. No.: US 2008/0239305 A1
(43) Pub. Date: Oct. 2, 2008

(54) Reticle assembly of aiming device

(75) Inventor: Kwok Hoo Mok, Hong Kong (CN)

Correspondence Address: BYIP, LTD., P.O. BOX 1484, GENERAL POST OFFICE, HONG KONG, CN

(73) Assignee: Alot Enterprise Company Limited

(21) Appl. No.: 11/727,768

(22) Filed: Mar. 28, 2007

(51) Int. Cl. G02B 23/10

(52) U.S. Cl. 356/252

(57) ABSTRACT

A reticle assembly of an aiming device is provided. The reticle assembly includes an illumination source, a first optical mask and a second optical mask. The first optical mask has a plurality of optical openings which define a reticle pattern. The first optical mask is mounted in a fixed position. The second optical mask is movably positioned relative to the first optical mask. The second optical mask has a plurality of masking portions adapted to block selected portions of the reticle pattern. The illumination source is adapted to project a plurality of output patterns which correspond to unblocked portions of the reticle pattern.

### FIELD OF THE APPLICATION

The present application relates generally to an aiming device, such as a riflescope, and particularly to a reticle assembly of an aiming device.

### BACKGROUND

A riflescope can be mounted on a rifle to assist a shooter in aiming the rifle at a target. The riflescope includes a reticle assembly having reticle patterns for producing output patterns. The reticle patterns are usually in the shape of dots, posts, cross hairs, circles, or a combination thereof. It is desirable to use a riflescope having multiple reticle patterns rather that a riflescope with only a single reticle pattern. With multiple reticle patterns, the shooter can select different reticle patterns suitable for different shooting conditions.

FIG. 1 is an exploded perspective view of a known reticle assembly 10 of an aiming device. The reticle assembly 10 includes a multi-reticle plate 12 fixedly mounted on a reticle holder 14. The reticle plate holder 14 can be held in one of the selected positions within the reticle assembly 10 by a steel ball 16 and a spring 18. An illumination source, such as a light emitting diode (LED) 22, is fixed within a LED holder 24 which is fixedly coupled to a base 20 through an axle 26. The reticle plate holder 14 is connected to a knob 28. The knob 28 is in turn connected to a turncap 30 by a bolt 32. By turning the turncap 30, the reticle plate holder 14 rotates relative to the LED holder 24. An O-ring 34 is used to seal the reticle assembly 10.

In use, the LED 22 projects an output pattern 36 on an imaging board 38, as shown in FIG. 2. The imaging board 38 is adapted to display the projected output pattern 36 on the aiming device for aiming purpose. The multi-reticle plate 12 has four groups of optical openings for the projection of four different output patterns respectively. These four output patterns include a “dot with 4-post” output pattern 40, a 4-post output pattern 42, a “dot with 3-post” output pattern 44, and a dot output pattern 46.

By turning the multi-reticle plate 12, as illustrated in FIGS. 3(a)-3(d), a particular reticle pattern can be selected for a particular shooting condition.

According to the structural arrangement of the reticle assembly 10, the multi-reticle plate 12 is not directly fixed to the LED holder 24. When the multi-reticle plate 12 remains in a normal position relative to the LED 22 and the LED holder 24, the output patterns 40, 44, 46 are properly projected, as illustrated in FIG. 4. However, the position of the multi-reticle plate 12 relative to the LED 22 and the LED holder 24 may be changed due to the strong impact delivered to the reticle assembly 10 after rounds of shooting. When the multi-reticle plate 12 is dislocated, the output patterns 40, 44, 46 are shifted, as illustrated in FIG. 5. This affects the aiming accuracy of the aiming device.

### SUMMARY

In one aspect, a reticle assembly of an aiming device is provided. The reticle assembly includes an illumination source, a first optical mask and a second optical mask. The first optical mask has a plurality of optical openings which define a reticle pattern. The first optical mask is mounted in a fixed position. The second optical mask is movably positioned relative to the first optical mask. The second optical mask has a plurality of masking portions adapted to block selected portions of the reticle pattern. The illumination source is adapted to project a plurality of output patterns which correspond to unblocked portions of the reticle pattern.

In another aspect, a riflescope is provided. The riflescope has a reticle assembly which includes an illumination source, a first optical mask and a second optical mask. The first optical mask has a plurality of optical openings which define a reticle pattern. The first optical mask is mounted in a fixed position. The second optical mask is movably positioned relative to the first optical mask. The second optical mask has a plurality of masking portions adapted to block selected portions of the reticle pattern. The illumination source is adapted to project a plurality of output patterns which correspond to unblocked portions of the reticle pattern.

### BRIEF DESCRIPTION OF THE DRAWINGS

FIG. 1 is an exploded perspective view of a known reticle assembly of the prior art.

FIG. 2 illustrates the projection of an output pattern on an imaging board using the reticle assembly of FIG. 1.

FIGS. 3(a)-3(d) illustrate the selection of reticle patterns by changing the position of the multi-reticle plate of the reticle assembly of FIG. 1.

FIG. 4 shows a cross sectional view of the LED, the LED holder, and the multiple reticle patterns of the reticle assembly of FIG. 1, and illustrative diagrams showing the reticle patterns and corresponding projected output patterns under a normal condition.

FIG. 5 is similar to FIG. 4 except that it shows the shifting of the projected output patterns due to the change of position of the multiple reticle patterns relative to the LED and the LED holder.

FIG. 6 is an exploded perspective view of a reticle assembly according to an embodiment of the present application.

FIG. 7 illustrates the projection of an output pattern on an imaging board using the reticle assembly of FIG. 6.

FIGS. 8(a)-8(d) illustrate the selection of reticle patterns by moving one optical mask over another optical mask of the reticle assembly of FIG. 6.

FIG. 9 shows a cross sectional view of the LED, the LED holder, and the two optical masks of the reticle assembly of FIG. 6, and illustrative diagrams showing the optical masks and corresponding projected output patterns.

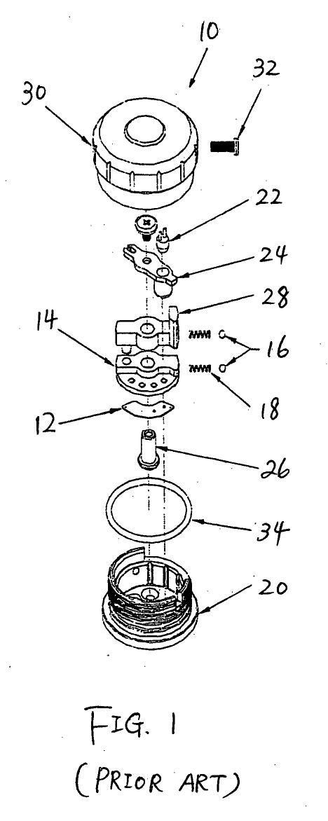

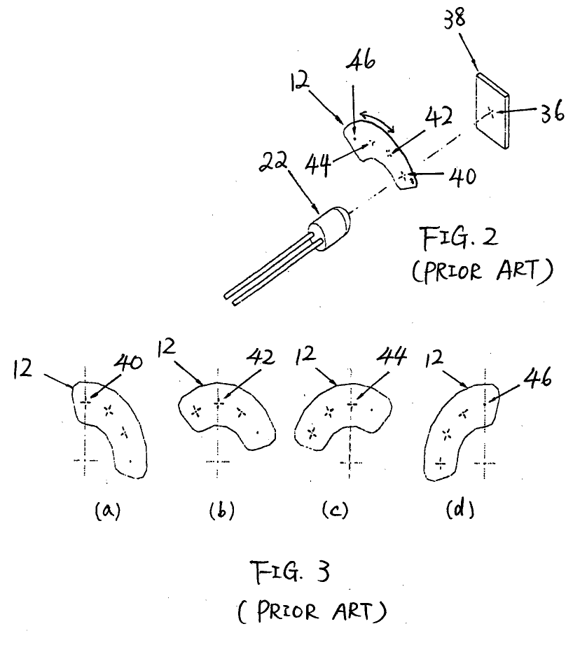

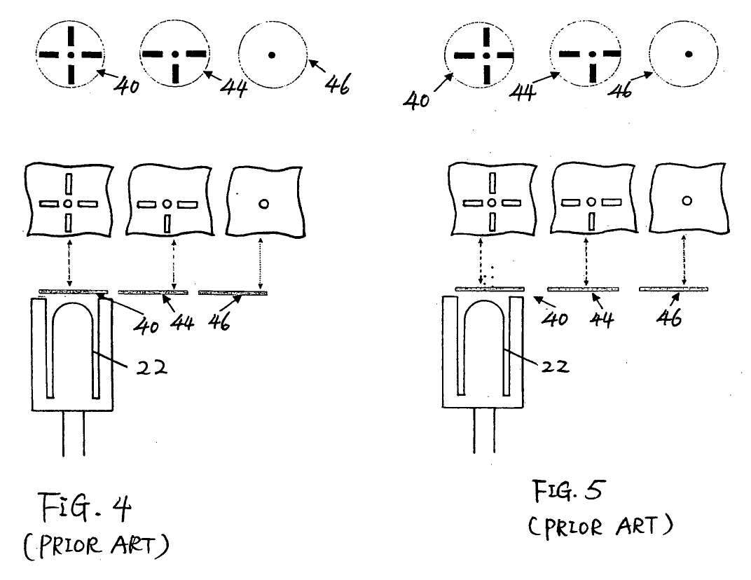

### DETAILED DESCRIPTION

It should be noted that throughout the specification and claims herein, when one element is said to be “coupled” to another, this does not necessarily mean that one element is fastened, secured, or otherwise attached to another element. Instead, the term “coupled” means that one element is either connected directly or indirectly to another element or is in mechanical or electrical communication with another element.

Referring to the drawings, in which like reference numerals represent like parts throughout the drawings, FIG. 6 is an exploded perspective view of a reticle assembly 110 according to an embodiment of present application.

The reticle assembly 110 includes a first optical mask 111 mounted on a LED holder 124 in a fixed position relative to an illumination source, such as a light emitting diode (LED) 122, inside the LED holder 124, and a second optical mask 112 mounted on an optical mask holder 114 rotatably coupled to the LED holder 124.

The optical mask holder 114 can be held in one of the selected positions within the reticle assembly 110 by a steel ball 116 and a spring 118. The LED 122 may be fixedly mounted within the LED holder 124, which is fixedly coupled to a base 120 through an axle 126. A turncap 130 may be fastened to the optical mask holder 114 by a bolt 132. An O-ring 134 may be used to seal the reticle assembly 110.

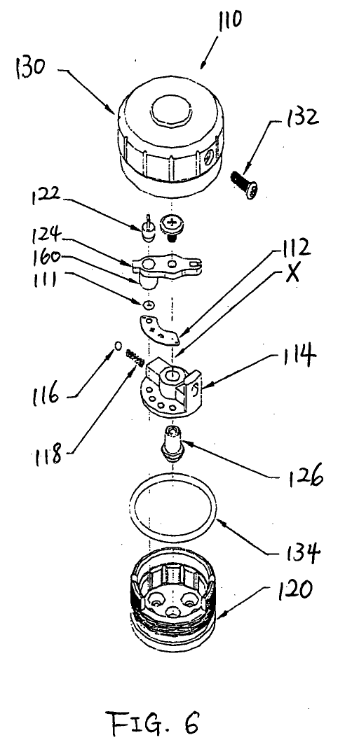

The LED 122 can be adapted to project an output pattern 136 on an imaging board 138, as shown in FIG. 7.

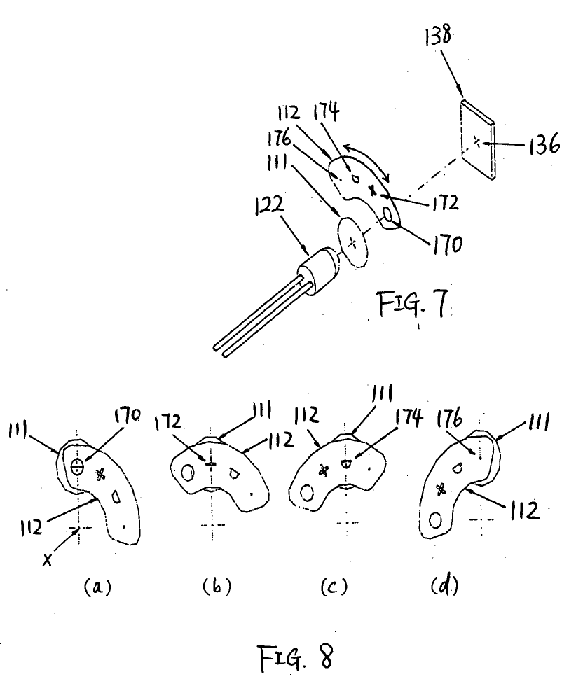

By turning the turncap 130, the optical mask holder 114 rotates about an axis of rotation X. As the turncap 130 turns, the second optical mask 112, which is fixedly mounted on the turncap 130, moves relative to the first optical mask 111, as illustrated in FIGS. 8(a)-8(d). This allows the shooter to select a particular reticle pattern for a particular shooting condition.

Detailed embodiments of the first optical mask 111, the second optical mask 112, and the formation and selection of output patterns by the first and second optical masks 111, 112 will be described hereinbelow.

As shown in FIG. 9, the first optical mask 111 can be fixedly mounted on a housing 160 which is integrally formed with the LED holder 124. In the illustrated embodiment, the first optical mask 111 may be disposed at a fixed position relative to the LED 122, which is fixedly mounted within the LED holder 124.

According to the illustrated embodiment, the first optical mask 111 may be in the form of a circular reticle disk. The housing 160 may be cylindrical in shape and may include a cylindrical body having two opposite ends. The LED 122 may be fixedly mounted within the housing 160 at one end thereof, and the first optical mask 111 may be fixedly mounted on the housing 160 at the other end thereof.

When the LED 122 is activated, a beam of light can be directed towards the first optical mask 111. The LED 122 may be battery powered and employed to emit a beam of light which can project on the aiming device an output pattern. The LED may be in red color for easy night visibility. Although it has been described that the illumination source of the reticle assembly is a LED, it is understood by one skilled in the art that the illumination source may be of any other suitable light source.

The first optical mask 111 may be made of an opaque material which does not allow passage of light therethrough. The first optical mask 111 may have a plurality of optical openings which defines a reticle pattern 113. The optical openings allow light to pass through.

According to the illustrated embodiment, the reticle pattern 113 may be a “dot with 4-post” pattern, which is a combination of a dot reticle and a 4-post reticle, as best illustrated in FIG. 9. The dot may be located at the center of the first optical mask 111 and the four posts may be located at the conventional 3 o'clock, 6 o'clock, 9 o'clock and 12 o'clock positions around the central dot.

Although it has been described in the present embodiment that the reticle pattern 113 is a combination of a dot reticle and a 4-post reticle, it is appreciated by one skilled in the art that the reticle pattern 113 can be a combination of dot, post, line, circle, and cross hair reticles, as well as reticles of other possible shapes.

The second optical mask 112 may be in the form of a disk, or a plate of any appropriate shape. According to the illustrated embodiment, the second optical mask 112 may be in the form of an arc-shaped plate. The second optical mask 112 may be made of an opaque material or any other suitable material which does not allow passage of light therethrough.

The second optical mask 112 has masking portions for blocking selected portions of the reticle pattern 113 of the first optical mask 111 to form output patterns 140, 144, 146. According to the illustrated embodiment in FIG. 9, there may be three masking portions 170, 174, 176.

The first masking portion 170 may be in the form of an opening or made of a transparent material which does not block any portion of the reticle pattern 113 thereby forming the same “dot with 4-post” output pattern 140 as the reticle pattern 113.

The second masking portion 174 may be in a shape configured to block only one of the four posts of the 4-post reticle pattern to form a “dot with 3-post” output pattern 144.

The third masking portion 176 may be an aperture configured to block the entire four posts of the 4-post reticle pattern to form a target dot output pattern 146.

According to another embodiment shown in FIG. 8(a)-(d), a fourth masking portion 172 may be provided on the second optical mask 112. The fourth masking portion 172 may be in a shape configured to block the centrally oriented dot reticle of the “dot with 4-post” reticle pattern to form a 4-post output pattern.

According to the above-mentioned embodiments, the output patterns may include a “one dot with 4-post” output pattern 140, a “dot with 3-post” output pattern 144, a target dot output pattern 146, and a 4-post output pattern.

By moving the second optical mask 112 relative to the first optical mask 111, the output pattern 140, 144, or 146 can be formed. The shooter can select a particular output pattern for a particular shooting condition.

In use, the LED 122 may be activated to direct a beam of light towards the first optical mask 111 which may be mounted in fixed position relative to the LED 122 and in turn to the aiming device.

The first optical mask 111 may have a plurality of optical openings which define a reticle pattern 113. According to the illustrated embodiment, the reticle pattern 113 is a “dot with 4-post” pattern, which is a combination of a dot reticle and a 4-post reticle. The second optical mask 112 may have a plurality of masking portions. According to the illustrated embodiment in FIG. 9, the second optical mask 112 may have three masking portions.

To select an output pattern, the shooter can turn the turncap 130 which is rotatably mounted on the aiming device. This moves the second optical mask 112 relative to the first optical mask 111.

To select a “dot with 4-post” output pattern 140, the shooter can turn the turncap 130 and move the opening 170 of the second optical mask 112 over the first optical mask 111.

To select a “dot with 3-post” output pattern 144 , the shooter can turn the turncap 130 and move the masking portion 174 of second optical mask 112 over the first optical mask 111 to block one of the four posts of the 4-post reticle pattern.

To select a dot output pattern 146, the shooter can turn the turncap 130 and move the masking portion 176 of the second optical mask 112 over the first optical mask 111 to block the four posts of the 4-post reticle pattern.

By selectively moving the turncap 130, the shooter can select the output pattern 140, 144, or 146 for aiming purpose. The output pattern may then be projected on an imaging board of the aiming device.

According to the illustrated embodiment in FIGS. 8(a)-8(d), the second optical mask 112 may have another masking portion 172. This allows the shooter to move the second optical mask 112 relative the first optical mask 111 to block the centrally oriented dot reticle of the “dot with 4-post” reticle pattern.

Since the first optical mask 111 is mounted in a fixed position, it can withstand the strong firing impact delivered to the reticle assembly 110 of the aiming device. The output patterns so projected would not be easily shifted and the aiming accuracy can be maintained at a high level.

While the present application has been shown and described with particular references to a number of preferred embodiments thereof, it should be noted that various other changes or modifications may be made without departing from the scope of the present application.

What is claimed is:

1. A reticle assembly of an aiming device comprising:
(a) an illumination source;
(b) a first optical mask comprising a plurality of optical openings which define a reticle pattern, said first optical mask being mounted in a fixed position; and
(c) a second optical mask movably positioned relative to said first optical mask, said second optical mask comprising a plurality of masking portions adapted to block selected portions of said reticle pattern, said illumination source adapted to project a plurality of output patterns which correspond to unblocked portions of said reticle pattern.

2. The reticle assembly as claimed in claim 1 wherein said first optical mask is fixedly mounted on a housing in which said illumination source is provided.

3. The reticle assembly as claimed in claim 1 wherein said first optical mask is in the form of a reticle disk fixedly mounted at one end of a cylindrical housing in which said illumination source is mounted at the other end thereof.

4. The reticle assembly as claimed in claim i wherein said second optical mask is fixedly mounted on a first holder which is rotatably coupled to a second holder holding said first optical mask and said illumination source.

5. The reticle assembly as claimed in claim 1 wherein said second optical mask is in the form of an arc-shaped plate.

6. The reticle assembly as claimed in claim 1 wherein said reticle pattern is a “dot with 4-post” pattern which is a combination of a dot reticle and a 4-post reticle.

7. The reticle assembly as claimed in claim 6 wherein said masking portions comprise a shape configured to block one post of said 4-post reticle and to form a “dot with 3-post” output pattern.

8. The reticle assembly as claimed in claim 6 wherein said masking portions comprise an aperture configured to block said 4-post reticle and to form a dot output pattern.

9. The reticle assembly as claimed in claim 6 wherein said masking portions comprise a shape configured to block said dot reticle and to form a 4-post output pattern.

10. The reticle assembly as claimed in claim 6 wherein said masking portions comprise an opening without blocking said dot reticle and said 4-post reticle and to form a “dot with 4-post” output pattern.

11. The reticle assembly as claimed in claim 1 wherein said second optical mask is fixedly coupled to a turncap rotatably mounted on said aiming device.

12. The reticle assembly as claimed in claim 1 wherein said illumination source is a light-emitting diode.

13. A riflescope comprising a reticle assembly, the reticle assembly comprising:
(a) an illumination source;
(b) a first optical mask comprising a plurality of optical openings which define a reticle pattern, said first optical mask being mounted in a fixed position; and
(c) a second optical mask movably positioned relative to said first optical mask, said second optical mask comprising a plurality of masking portions adapted to block selected portions of said reticle pattern, said illumination source adapted to project a plurality of output patterns which correspond to unblocked portions of said reticle pattern.

14. A method of forming output patterns on an aiming device comprising the steps of:
(a) providing an illumination source;
(b) providing a first optical mask comprising a plurality of optical openings which defines a reticle pattern, said first optical mask being mounted in a fixed position;
(c) providing a second optical mask movably positioned relative to said first optical mask, said second optical mask comprising a plurality of masking portions;
(d) moving said second optical mask relative to said first optical mask to block selected portions of said reticle pattern to form said output patterns which correspond to unblocked portions of said reticle pattern.

15. The method of claim 14 wherein said output patterns are projected on an imaging board of said aiming device.

16. The method of claim 14 wherein said reticle pattern is a “dot with 4-post” reticle pattern which is a combination of a dot reticle and a 4-post reticle.

17. The method of claim 16 wherein the step (d) comprising moving said second optical mask relative to said first optical mask to block one post of said 4-post reticle to form a “dot with 3-post” output pattern.

18. The method of claim 16 wherein the step (d) comprising moving said second optical mask relative to said first optical mask to block said 4-post reticle to form a dot output pattern.

19. The method of claim 16 wherein the step (d) comprising moving said second optical mask relative to said first optical mask to block said dot reticle to form a 4-post output pattern.

20. The method of claim 16 wherein the step (d) comprising moving said second optical mask relative to said first optical mask without blocking said dot reticle and said 4-post reticle to form a “dot with 4-post” output pattern.
